(19) United States
(12) Patent Application Publication
(10) Pub. No.: US 2014/0312107 A1
(43) Pub. Date: Oct. 23, 2014

(54) HANDLE FOR PAPER BOARD ARTICLE

(71) Applicant: H.B. FULLER COMPANY, ST. PAUL, MN (US)

(72) Inventor: JORGE A. NASH, Vancouver, WA (US)

(73) Assignee: H.B. FULLER COMPANY, ST. PAUL, MN (US)

(21) Appl. No.: 13/867,653

(22) Filed: Apr. 22, 2013

(51) Int. Cl. B65D 5/46; B31B 1/86

(52) U.S. Cl. CPC B65D 5/46016; B31B 1/86
USPC 229/117.23; 220/768; 493/88

(57) ABSTRACT

A container comprising:
at least one panel or flap configured to form a top, wall, or bottom of the container, wherein the panel or flap comprises a paper board and defines an exterior surface and an interior surface and at least one longitudinally-elongated opening; and
at least one handle, each handle comprising a flexible strip forming a collapsible loop having a continuous curvature along the full length of the loop that extends through the length of the longitudinally-elongated opening in the container, wherein first and second portions of the flexible strip are adhesively affixed to the interior surface of the panel or flap of the top, wall or bottom of the container.

### SUMMARY

Disclosed herein are several embodiments of a handle for a paper board article.

One embodiment is directed to a container comprising:

at least one panel or flap configured to form a top, wall, or bottom of the container, wherein the panel or flap comprises a paper board and defines an exterior surface and an interior surface and at least one longitudinally-elongated opening; and

at least one handle, each handle comprising a flexible strip forming a collapsible loop having a continuous curvature along the full length of the loop that extends through the length of the longitudinally-elongated opening in the container, wherein first and second portions of the flexible strip are adhesively affixed to the interior surface of the panel or flap of the top, wall or bottom of the container.

A further embodiment is an article comprising:

a paperboard substrate defining a first surface and an opposing second surface and one longitudinally-elongated opening; and

a handle comprising a flexible strip forming a collapsible loop having a continuous curvature along the full length of the loop that extends through the length of the longitudinally-elongated opening in the substrate, wherein first and second portions of the flexible strip are adhesively affixed to the first surface of the substrate.

An additional embodiment is a method for applying a handle to an article comprising:

providing at least one longitudinally-elongated opening in a panel or flap configurable to form a top, wall or bottom of a container, wherein the panel or flap comprises a paper board and defines an exterior surface and an interior surface;

inserting a handle into the opening in the panel or flap, wherein the handle comprises a flexible strip forming a collapsible loop having a continuous curvature along the full length of the loop that extends through the length of the longitudinally-elongated opening in the container; and

adhesively affixing first and second portions of the flexible strip to the interior surface of the panel or flap.

The foregoing will become more apparent from the following detailed description, which proceeds with reference to the accompanying figures.

### BRIEF DESCRIPTION OF THE DRAWINGS

FIG. 1 is a perspective view of the top portion of a first embodiment of a container;

FIG. 2 is a cross-sectional view taken substantially along the plane indicated by line 2-2 of FIG. 1;

FIG. 3 is a perspective view, with portions partially broken away, of the handle construction of the package of FIG. 1;

FIG. 4 is a cross-sectional view taken substantially along the plane indicated by line 4-4 of FIG. 1;

FIG. 5 is a perspective view of the top portion of a second embodiment of a container:

FIG. 6 is a cross-sectional view taken substantially along the plane indicated by line 3-3 of FIG. 5;

FIG. 7 is a perspective view, with portions partially broken away, of the handle construction of the package of FIG. 5;

FIG. 8 is a cross-sectional view taken substantially along the plane indicated by line 1-1 of FIG. 5;

FIG. 9 is a perspective view of the top portion of a third embodiment;

FIG. 10 is a cross-sectional view taken substantially along the plane indicated by line 5-5 of FIG. 9;

FIG. 11 is a cross-sectional view taken substantially along the plane indicated by line 6-6 of FIG. 9;

FIG. 12 is a perspective view of the top portion of a fourth embodiment of a container;

FIG. 13 is a top view taken substantially along the plane indicated by line A-A of FIG. 12;

FIG. 14 is a bottom view taken substantially along the plane indicated by line B-B of FIG. 12;

FIG. 15 is a perspective view of the top portion of a fifth embodiment of a container;

FIG. 16 is a top view taken substantially along the plane indicated by A-A of FIG. 15;

FIG. 17 is a perspective view of the top portion of a sixth embodiment of a container;

FIG. 18 is a cross-sectional view taken substantially along the plane indicated by line C-C of FIG. 17; and

FIG. 19 is a perspective view of the top portion of a seventh embodiment of a container.

### DETAILED DESCRIPTION

Described herein are embodiments of a handle for an article, such as paper board or corrugated paper board containers. The handle includes a flexible strip forming a loop that is affixed to an interior surface of a panel or flap of the corrugated or paperboard package. The strip extends through a complementary opening on the panel or flap and can extend vertically because of the formed loop to form a hand hold. The complementary opening may be covered by a panel larger than the complementary opening, wherein the panel is affixed to the interior surface of the panel or flap overlapping the strip affixed to the interior surface of the panel. Generally, the handle may be applied to a paperboard substrate or corrugated paperboard substrate during manufacturing of the substrate (e.g., a container blank). The handle disclosed herein is not a pre-formed handle unit (i.e., a two-part unit that includes a handle and a carrying element).

In certain embodiment, the substrate may be a corrugated paper board. The corrugated board substrate includes an exterior liner and a corrugated member. In some implementations, the corrugated member consists of a series of parallel flutes. However, in other implementations, the corrugated member can include other configurations, such as a waffle-type pattern or honeycomb. The corrugated paper board may be a single wall structure (i.e., includes a single fluted corrugated medium and at least one liner layer) or a multiwall structure (i.e., includes at least two fluted corrugated mediums and at least one liner layer). One or more substrates can form an article of manufacture such as a packaging container. Examples of packaging containers include cartons and boxes, such as cartons for holding beverages for sale at the retail level (for instance, a hand-carry carton that holds six, 12 or 24 bottles or cans of a beverage), meat and produce bulk bills, wet-packed containers, reusable containers, rubber and chemical bulk bins, heavy duty containers, bags, electronics and envelopes. A continuous corrugated board substrate can be manufactured by bonding the corrugated member to the exterior liner using an adhesive, and subjecting the exterior liner and corrugated member to heat.

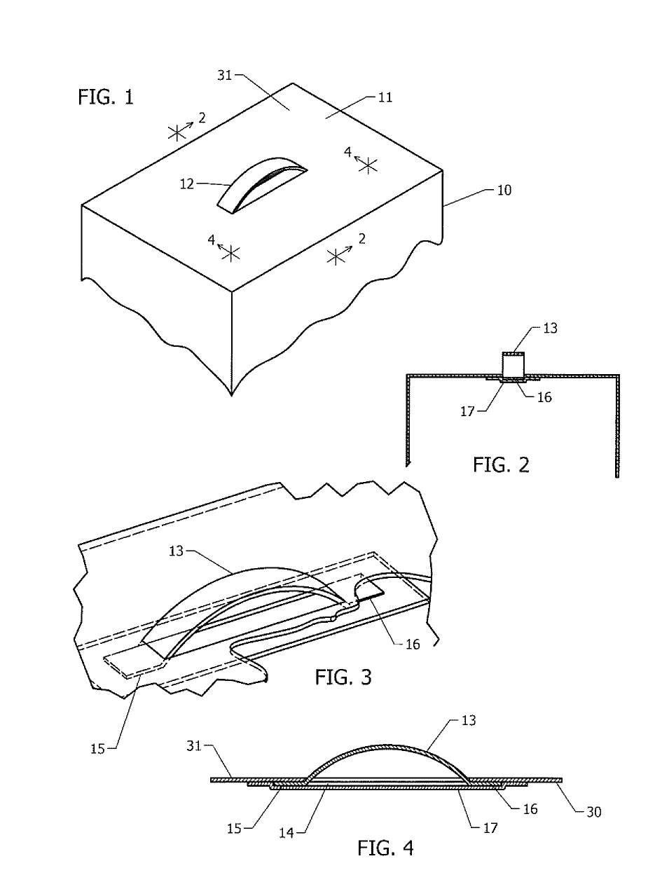

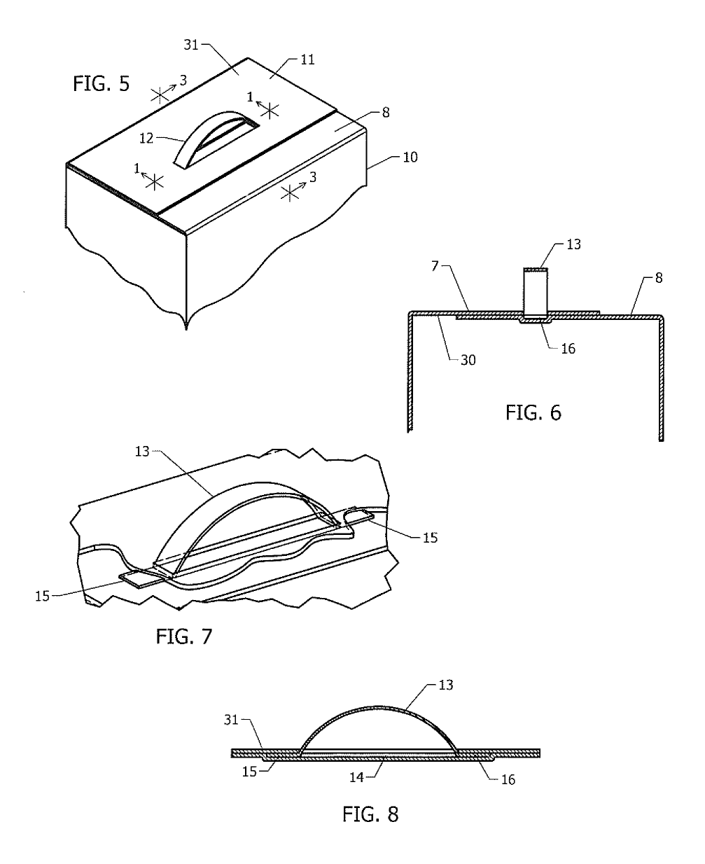

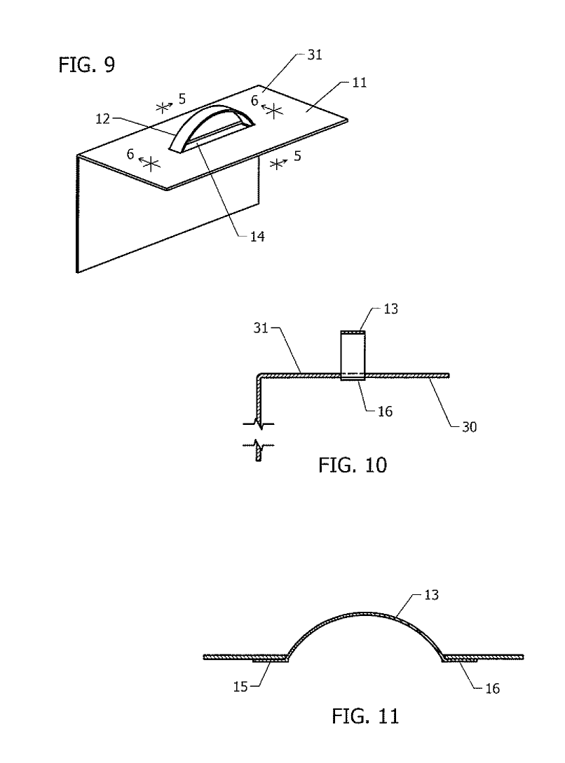

Referring to the figures in detail, wherein like numerals indicate like elements throughout the several views, a container 10 is provided with a top 11. In FIGS. 1-4, the longitudinal direction of the container is indicated by arrow 2, the axial direction of the container is indicated by arrow 4. In FIGS. 5-8, the longitudinal direction of the container is indicated by arrow 3; the axial direction of the container is indicated by arrow 1. In FIGS. 9-11, the longitudinal direction of the container is indicated by arrow 5, the axial direction of the container is indicated by arrow 6.

The container can be constructed of corrugated or folding carton paperboard. The top 11 has a centrally located, longitudinally-elongated opening 14. Adhesively affixed to an interior surface 30 of the top 11 is a handle 12. Container 10 also defines an exterior surface 31 opposing interior surface 30. The handle structure 12 includes a flexible strip forming a loop 13 made from a material such as a non-woven fiber, film, tape, paperboard, or a combination thereof (e.g., a composite laminate) so that a length of the handle material greater than the longitudinal length of the opening 14 can be provided in the opening 14 which when extended upward will allow a hand there through to carry the container 10. End portions 15 and 16 of the strip forming the handle 12 are adhesively secured to the interior surface 30 of the top 11 adjacent opening 14, and the flexible loop 13 is then extended or deflected through the opening 14 into the top 11. The collapsible loop 13 has a continuous curvature that extends along the full length of the loop 13. For example, the collapsible loop 13 does not include a pleat or similar discontinuity along the length of the loop. As shown in FIG. 1, there is a single longitudinally-elongated opening 14 per handle 12 and the handle 12 extends the full length of the opening 14. In certain embodiments, the opening 14 has a rectilinear shape.

As mentioned above, the material for forming the flexible strip of the handle may be a non-woven fiber, film, tape, paperboard, or a combination thereof (e.g., a composite laminate). In one particular example, the material is a tape with a coating of adhesive applied to a substrate such as, for example, a paper product. The material may include, but is not limited to, various ribbon materials, various web materials, and various widths and lengths of material. The materials may include films, non-woven materials, paper materials, composite or laminated tapes, tear tapes or reinforcement tapes such as Sesame® and Enforcer® tapes available from Adalis, and tapes with adhesives. Particularly preferred are flexible materials that can form a handle and that include an adhesive such as a hot melt adhesive, a pressure sensitive adhesive, a remoistenable adhesive, a heat activated adhesive, a hot melt pressure sensitive adhesive, a hot melt remoistenable adhesive, a water dispersible hot melt adhesive, a biodegradable hot melt adhesive or a repulpable hot melt adhesive. Examples of these adhesives are any typical hot melt adhesive such as an ethylene-vinyl acetate copolymer (EVA-based) hot melt adhesive; EMA-based hot melt adhesive (ethylene methylacrylate); EnBA-based hot melt adhesive (ethylene n-butyl acrylate); hot melt adhesive based on polyamides; hot melt remoistenable adhesive based on polyamides and copolyesters; hot melt adhesives based on polyethylene and polypropylene homopolymers, copolymers and interpolymers, rubbery block copolymer hot melt adhesives; or RF (radio frequency) activatable adhesives. The material, for example, may generally be an adhesive tape comprising a backing of between 2 mils (0.05 mm) to about 7 mils (0.18 mm) in thickness comprised of a polymeric web selected from the group comprising polyester, polypropylene, polyethylene, and mixtures thereof.

In certain embodiments, in order to preclude contaminants from entering container 10 through opening 14 in the top 11, a panel 17 larger in area compared to opening 14 is adhesively secured to the interior surface of the top 11 bordering opening 14 and sandwiching the end portions 15 and 16 between the adhering surface of the panel 17 and the interior surface of the top 11. In certain embodiments the cover panel is complementary in shape to the opening in the top of the container. In use, the flexible loop 13 enables it to be extended and raised upward through complementary opening 14 where it can be grasped by the hand in order to carry the package. The panel 17 precludes dirt or other contamination from entering the interior of the carton 10.

In a second embodiment shown in FIGS. 5-8, a container 10 is provided with a top 11 including a pair of overlapping flaps 7 and 8 which are connected together for example via an adhesive. The container 10 can be constructed of corrugated or folding carton paperboard. Closure flap 7 has centrally located, longitudinally-elongated opening 14. Connected to an interior surface 30 of the closure flap 7 is a flexible handle 12. Container 10 also defines an exterior surface 31. The handle structure 12 includes a flexible strip forming a loop 13 made from a material such as a non-woven fiber, film, tape, paperboard, or a combination thereof (e.g., a composite laminate) so that a length of the handle material greater than the longitudinal length of the opening 14 can be provided in the opening 14 which when extended upward will allow a hand there through to carry the container 10. End portions 15 and 16 of the strip forming the handle 12 are adhesively secured to the interior surface 30 of upper closure flap 7 adjacent opening 14, and the flexible loop 13 is then extended through the opening 14 in top flap 7. Closure flap 7 is then secured to the closure flap 8 and the loop 13 of handle 12 extends through the opening 14 thereof. The collapsible loop 13 has a continuous curvature that extends along the full length of the loop 13. For example, the collapsible loop 13 does not include a pleat or similar discontinuity along the length of the loop. As shown in FIG. 5, there is a single longitudinally-elongated opening 14 per handle 12 and the handle 12 extends the full length of the opening 14. In certain embodiments, the opening 14 has a rectilinear shape.

In order to preclude contaminants from entering container 10 through complementary opening 14 in the top flap 7, the lower flap 8 which has no such complementary opening is adhesively secured to the rear or interior surface of lower flap 8. In use, the flexible loop 13 enables it to be extended and raised upward through complementary opening 14 where it can be grasped by the hand in order to carry the package. The lower flap 8 precludes dirt or other contamination from entering the interior of the container 10.

In a third embodiment shown in FIGS. 9-11, a substrate has a centrally located, elongated opening 14. Connected to a first surface 30 of the substrate is a handle 12. The handle structure 12 includes a flexible strip forming a loop 13 made from a material such as a non-woven fiber, film, tape, paperboard, or a combination thereof (e.g., a composite laminate) so that a length of the handle material greater than the longitudinal length of the opening 14 can be provided in the opening 14 which when extended upward will allow a hand there through to carry the container 10. End portions 15 and 16 of the strip forming a handle 12 are adhesively secured to the interior surface 30.

In use, the flexible strip 13 enables it to be extended and raised upward through complementary opening 14 where it can be grasped by the hand in order to carry the substrate. The substrate can be constructed of corrugated or folding carton paperboard.

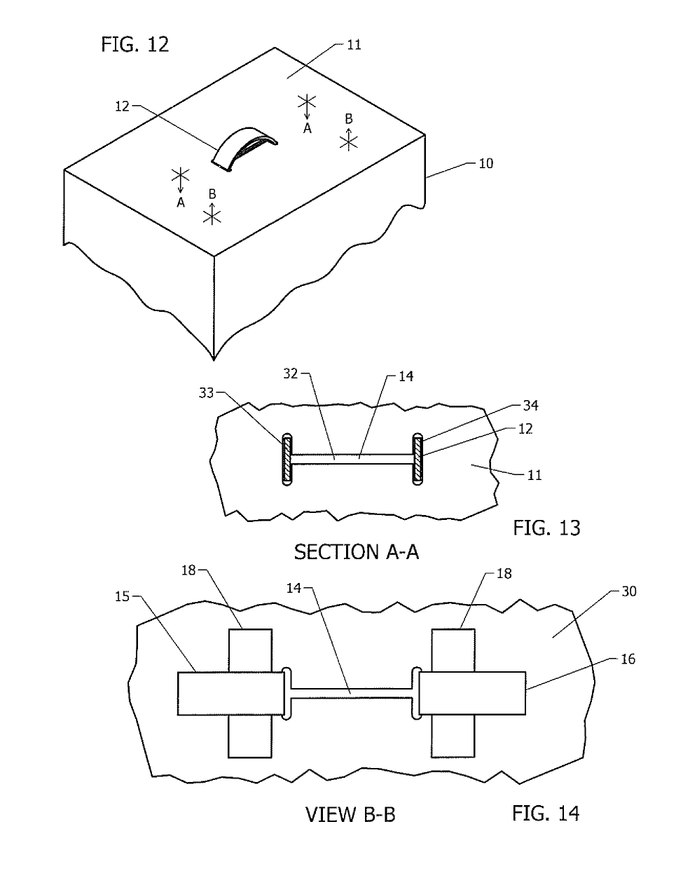

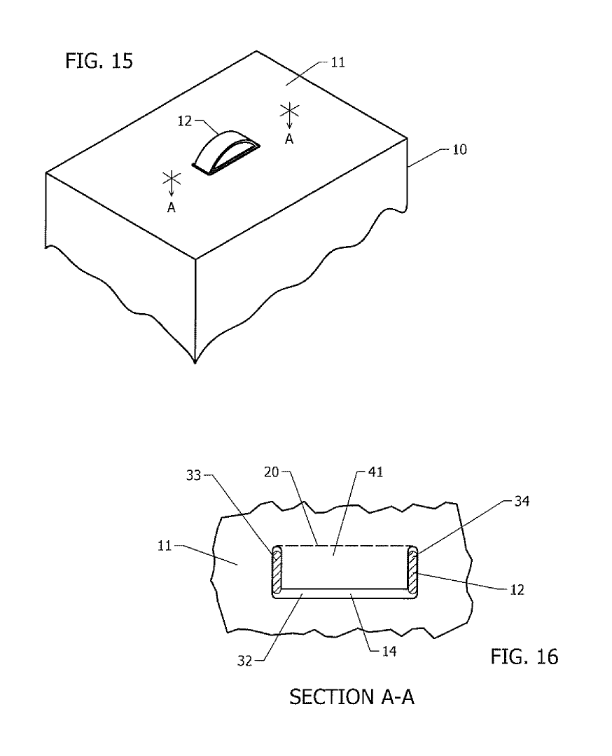

A fourth embodiment is shown in FIGS. 12-14. The top 11 of the container 10 is provided with a longitudinally-elongated opening 14 that includes a central longitudinally-elongated portion 32 extending between, and connecting, two opposing axially-extending portions 33 and 34. The handle 12 is received within the axially-extending portions 33 and 34, respectively. In the embodiment shown in FIG. 13 the central longitudinally-elongated portion 32 is located at a vertical mid-point of each of the two opposing axially-extending portions 33 and 34. In another embodiment shown in FIGS. 15 and 16, the central longitudinally-elongated portion 32 may be located at an end of each of the two opposing axially-extending portions 33 and 34. A score line 20 may be provided between the axially-extending portions 33 and 34 to provide a hingeable section 41 that is contiguous with opening 14. In the embodiment shown in FIG. 14, a reinforcing tape 18 is disposed between the interior surface 30 of container top 11 and the first and second end portions 15 and 16 of the handle 12. The first and second end portions 15 and 16 of the handle 12 may be adhesively affixed to the interior surface 30 and the reinforcing tape 18.

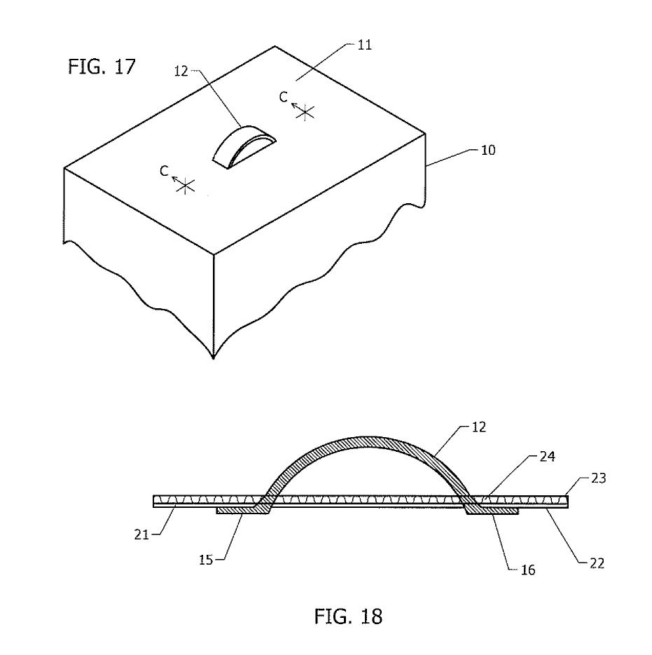

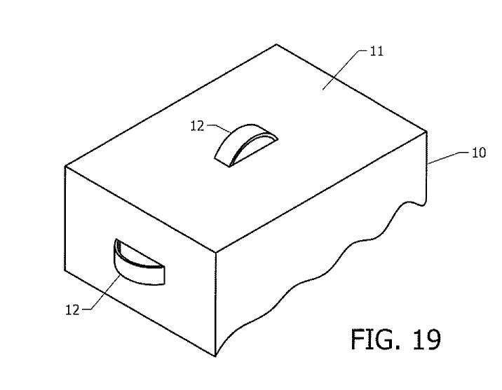

A further embodiment is shown in FIGS. 17 and 18. A reinforcement tape 21 is disposed between an interior liner 22, and corrugated flutes 24. An exterior liner 23 is disposed adjacent to the exterior surface of the corrugated flutes 24. End portions 15 and 16 of the handle 12 are adhesively affixed to the interior surface of the interior liner 22. The reinforcement tape 21 reinforces the container at the locations of the end portions 15 and 16.

In certain embodiments the flexible handle 12 can function as a strap for suspending on a hook, pulling, or restraining the container.

The handle may be applied to the substrate by any means. One illustrative method involves providing at least one longitudinally-elongated opening in a panel or flap configurable to form a top, wall or bottom of a container, wherein the panel or flap comprises a paper board and defines an exterior surface and an interior surface; inserting a handle into the opening in the panel or flap, wherein the handle comprises a flexible strip forming a collapsible loop having a continuous curvature along the full length of the loop that extends through the length of the longitudinally-extending opening in the container; and adhesively affixing first and second portions of the flexible strip to the interior surface of the panel or flap.

In view of the many possible embodiments to which the principles of the disclosed invention may be applied, it should be recognized that the illustrated embodiments are only preferred examples of the invention and should not be taken as limiting the scope of the invention.

What is claimed is:

1. A container comprising:
at least one panel or flap configured to form a top, wall, or bottom of the container, wherein the panel or flap comprises a paper board and defines an exterior surface and an interior surface and at least one longitudinally-elongated opening; and
at least one handle, each handle comprising a flexible strip forming a collapsible loop having a continuous curvature along the full length of the loop that extends through the length of the longitudinally-elongated opening in the container, wherein first and second portions of the flexible strip are adhesively affixed to the interior surface of the panel or flap of the top, wall or bottom of the container.

2. The container of claim 1, further comprising a second panel adhesively affixed to the interior surface of the top, wall, or bottom of the container, wherein the second panel defines an exterior surface and an interior surface and has sufficient dimension to cover the opening in the top, wall or bottom of the container, the second panel being positioned such that the first and second portions of the flexible strip are located between the exterior surface of the second panel and the interior surface of the top, wall or bottom of the container.

3. The container of claim 2, wherein the second panel comprises a substrate that does not form a part of the top, wall or bottom of the container.

4. The container of claim 2, wherein the second panel comprises a second flap that forms a part of the top, wall or bottom of the container.

5. The container of claim 2, wherein the second panel does not include an opening.

6. The container of claim 1, wherein the longitudinally-elongated opening includes a central longitudinally-elongated portion positioned between two opposing axially-extending portions.

7. The container of claim 6, wherein the central longitudinally-extending portion is located at a vertical mid-point of each of the two opposing axially-extending portions.

8. The container of claim 6, wherein the central longitudinally-extending portion is located at an end of each of the two opposing axially-extending portions.

9. The container of claim 8, wherein the panel or flap includes a score line configured to make a hingeable section continuous with the opening.

10. The container of claim 1, further comprising at least one reinforcing tape positioned near or at the first and second portions of the flexible strip.

11. The container of claim 1, wherein there is only a single continuous longitudinally-elongated opening per handle.

12. The container of claim 1, wherein the loop is disposed between, and contiguous with, the first and second portions.

13. The container of claim 1, wherein the container includes at least two handles.

14. An article comprising:
a paperboard substrate defining a first surface and an opposing second surface and one longitudinally-elongated opening; and
a handle comprising a flexible strip forming a collapsible loop having a continuous curvature along the full length of the loop that extends through the length of the longitudinally-elongated opening in the substrate, wherein first and second portions of the flexible strip are adhesively affixed to the first surface of the substrate.

15. A method for applying a handle to an article comprising:
providing at least one longitudinally-elongated opening in a panel or flap configurable to form a top, wall or bottom of a container, wherein the panel or flap comprises a paper board and defines an exterior surface and an interior surface;
inserting a handle into the opening in the panel or flap, wherein the handle comprises a flexible strip forming a collapsible loop having a continuous curvature along the full length of the loop that extends through the length of the longitudinally-elongated opening in the container; and
adhesively affixing first and second portions of the flexible strip to the interior surface of the panel or flap.
